(19) United States
(12) Patent Application Publication
(10) Pub. No.: US 2015/0092268 A1
(43) Pub. Date: Apr. 2, 2015

(54) IMAGE DISPLAY APPARATUS

(71) Applicant: Kabushiki Kaisha Toshiba, Minato-ku (JP)

(72) Inventors: Hiroshi HASEGAWA, Kanagawa-ken (JP); Shinichi Tatsuta, Tokyo (JP); Hidefumi Takamine, Tokyo (JP); Hideaki Okano, Kanagawa-ken (JP); Takahiro Kamikawa, Tokyo (JP)

(73) Assignee: Kabushiki Kaisha Toshiba, Minato-ku (JP)

(21) Appl. No.: 14/493,496

(22) Filed: Sep. 23, 2014

(30) Foreign Application Priority Data
Sep. 30, 2013 (JP) 2013-205872

(51) Int. Cl. G02B 27/22; G02B 7/02

(52) U.S. Cl. CPC G02B 27/2214; G02B 7/023; G02B 3/005
USPC 359/463

(57) ABSTRACT

An image display apparatus according to an embodiment includes a recording medium on which a composite image obtained by composing a plurality of images corresponding to respective parallaxes is printed by a print apparatus, a lenticular lens having a plurality of cylindrical lenses arranged side by side, and configured to display the composed image separately for each direction of parallax, and a position adjustment mechanism configured to adjust relative position of the recording medium and the lenticular lens, and the position adjustment mechanism includes an inclination adjustment unit capable of changing an inclination angle of at least one of the recording medium and the lenticular lens, and a horizontal adjustment unit capable of moving at least one of the recording medium and the lenticular lens in a substantially perpendicular direction to a border line of the cylindrical lens, and the inclination adjustment unit and the horizontal adjustment unit can make adjustment independently, and a rotation center of the inclination adjustment unit is provided at a portion of the horizontal adjustment unit, and the inclination angle can be changed on the basis of the rotation center which is a reference.

### FIELD

Embodiments of the present invention relate to an image display apparatus.

### BACKGROUND

There is a conventional image display apparatus that displays an image which appears to be differently depending on the direction a person sees the image, so that the image appears to be stereoscopic, and for example, in order to display parallax images which are shown in multiple directions and which can be seen in multiple directions, a composite image obtained by composing parallax images is recorded onto a recording medium such as a sheet by means of printing, and the image is displayed through a lenticular lens. The composite image is made by arranging multiple parallax images in a rectangular form, and the same parallax image is displayed in the same direction by many cylindrical lenses constituting the lenticular lens.

In this case, when the position of the composite image printed on the recording medium does not match the position of the lenticular lens, the image displayed is corrupted in a conventional image display apparatus. In the conventional image display apparatus, the positional deviation includes horizontal positional deviation and inclination deviation, but it is difficult to independently adjust both of them, and it has not been easy to adjust the positions.

### BRIEF DESCRIPTION OF THE DRAWINGS

FIG. 1 is a configuration diagram illustrating an image display apparatus according to a first embodiment.

FIGS. 2(a) and 2(b) are transverse sectional views illustrating the image display apparatus according to the first embodiment.

FIG. 3 is a longitudinal sectional view illustrating a lenticular lens unit of the image display apparatus according to the first embodiment.

FIGS. 4(a) to 4(c) are figures illustrating a method for forming a recording medium for the image display apparatus according to the first embodiment.

FIG. 5 is a first flowchart illustrating a method for assembling the image display apparatus according to the first embodiment.

FIG. 6 is a second flowchart illustrating a method for assembling the image display apparatus according to the first embodiment.

FIG. 7 is a longitudinal sectional view illustrating an image display apparatus according to a second embodiment.

FIG. 8 is a longitudinal sectional view illustrating an image display apparatus according to a third embodiment.

FIG. 9 is a longitudinal sectional view illustrating an image display apparatus according to a fourth embodiment.

FIG. 10 is a longitudinal sectional view illustrating an image display apparatus according to a fifth embodiment.

FIG. 11 is a longitudinal sectional view illustrating an image display apparatus according to a sixth embodiment.

FIG. 12 is a longitudinal sectional view illustrating an image display apparatus according to a seventh embodiment.

### DETAILED DESCRIPTION

Embodiments will be hereinafter explained with reference to drawings.

### First Embodiment

An image display apparatus according to a first embodiment will be hereinafter explained with reference to drawings.

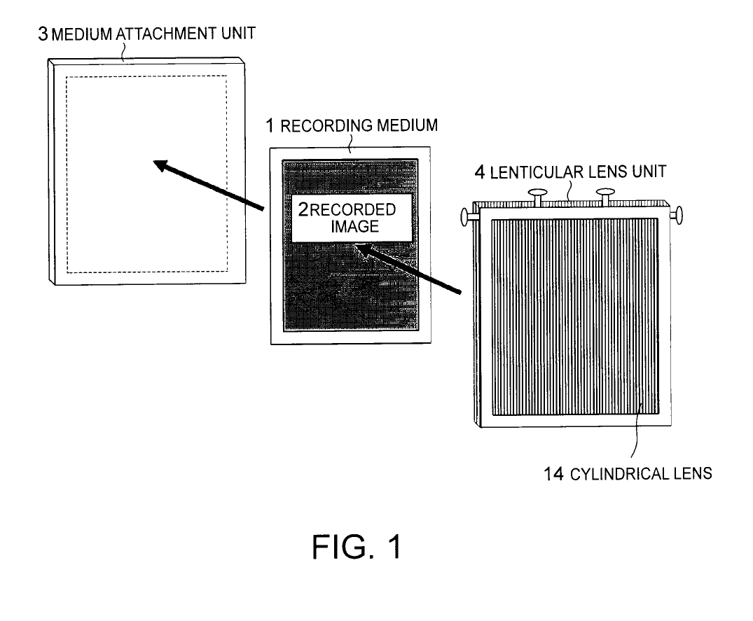

First, overview of the image display apparatus of the first embodiment will be explained with reference to FIG. 1. FIG. 1 is a configuration diagram illustrating the image display apparatus according to the first embodiment.

As shown in FIG. 1, a recording medium 1 is formed with a recorded image 2, and, for example, the recording medium 1 is attached to a medium attachment unit 3 which is a flat plate. A lenticular lens unit 4 is attached so that it is in contact with the recording medium 1 attached to the medium attachment unit 3.

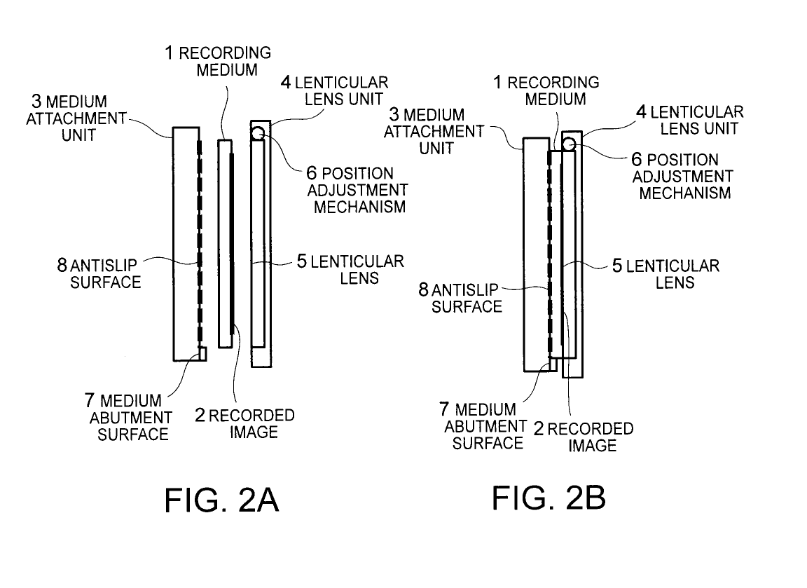

The image display apparatus according to the first embodiment before and after the assembly will be explained with reference to FIG. 2. FIG. 2 is a transverse sectional view illustrating the image display apparatus according to the first embodiment.

FIG. 2(a) schematically illustrates the image display apparatus according to the first embodiment before the assembly, and as shown in FIG. 2(a), the recording medium 1 is formed with the recorded image 2, and the recording medium 1 is attached to the medium attachment unit 3, and thereafter, the lenticular lens unit 4 is attached to the recording medium 1.

Therefore, while a lenticular lens 5 is brought into contact with the recorded image 2, a position adjustment mechanism 6 is adjusted. In this case, the lenticular lens 5 is configured in such a manner that many inverted U-shaped cylindrical lenses 14 are arranged side by side. In FIGS. 2(a), 2(b), the vertical direction of the drawings is a direction substantially in parallel with the border lines between the cylindrical lenses 14, like the subsequent drawings. In FIGS. 2(a), 2(b), the horizontal direction of the drawings is a direction substantially perpendicular to the border lines between the cylindrical lenses 14, like the subsequent drawings

The position of the recording medium 1 is somewhat determined by a medium abutment surface 7, but antislip processing is applied to the medium attachment surface of the medium attachment unit 3, or a antislip sheet is pasted to the medium attachment surface of the medium attachment unit 3, whereby it is made into an antislip surface 8, so that the recording medium 1 does not move together with the lenticular lens 5 when the lenticular lens 5 moves on the recording medium 1.

FIG. 2(b) schematically illustrates the image display apparatus according to the first embodiment after the assembly, and as shown in FIG. 2(b), the medium attachment unit 3 and the lenticular lens unit 4 are fixed with screws or hooks, not shown, so as to maintain such state as to press the lenticular lens 5 and the recorded image 2 having been adjusted.

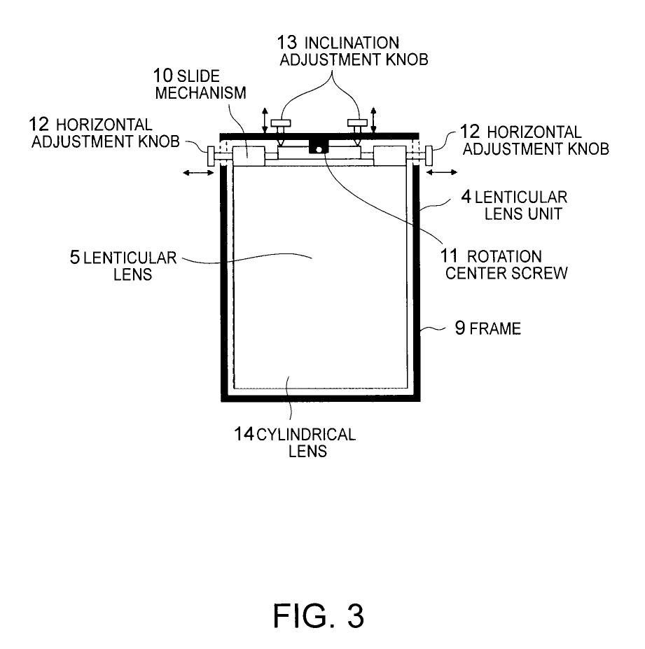

In this case, the lenticular lens unit 4 has the position adjustment mechanism 6. FIG. 3 is a longitudinal sectional view illustrating a lenticular lens unit of the image display apparatus according to the first embodiment.

As shown in FIG. 3, the lenticular lens 5 is connected via a rotation center screw 11 with a slide mechanism 10 provided at an upper portion of FIG. 3 with respect to a frame 9.

In this case, horizontal adjustment knobs 12 (hereinafter referred to as a horizontal adjustment unit) are provided to connect with the slide mechanism 10, and for example, in a case where the slide mechanism 10 is of a direct-acting method, a user grabs one of or both of the knobs and moves the knobs in a horizontal direction (which will hereinafter refer to a direction substantially perpendicular to the border lines of the cylindrical lens 14 constituting the lenticular lens 5), so that the slide mechanism 10 connected with the lenticular lens 5 can be adjusted in the horizontal direction of FIG. 3. In a case where the slide mechanism 10 is of a feed screw method, a user rotates one of or both of the knobs, so that the slide mechanism 10 connected with the lenticular lens 5 can be adjusted in the horizontal direction of FIG. 3. In a case where the horizontal adjustment knobs 12 are of a screw method, the position in the horizontal direction is less likely to deviate from the adjusted state because of the friction of the screw even if the user releases his or her hand from the horizontal adjustment knobs 12 after the adjustment.

Further, inclination adjustment knobs 13 (which will be hereinafter also referred to as an inclination adjustment unit) are provided to be in contact with a component connected with the rotation center screw 11 of the slide mechanism 10, and for example, in a case where the inclination adjustment knobs 13 are a direct-acting method, a user grabs one of or both of the knobs of the inclination adjustment knobs 13 at the right and the left and moves the knobs in the vertical direction (which will hereinafter refer to a direction substantially in parallel with the border lines of the cylindrical lens 14 constituting the lenticular lens), and pushes or pulls the contact portions at the right and the left of the inclination adjustment knobs 13, so that the user can adjust the inclination of the component connected with the rotation center screw 11 of the slide mechanism 10 connected with the lenticular lens 5 with respect to the rotation center screw 11 serving as the center of rotation. In a case where the inclination adjustment knobs 13 are of a feed screw method, a user rotates one of or both of the knobs of the inclination adjustment knobs 13, and pushes or pulls the contact portions at the right and the left of the inclination adjustment knobs 13, so that the user can adjust the inclination of the component connected with the rotation center screw 11 of the slide mechanism 10 connected with the lenticular lens 5 with respect to the rotation center screw 11 serving as the center of rotation. When the inclination adjustment knobs 13 are of a screw method, the inclination is less likely to deviate from the adjusted state because of the friction of the screw even if the user releases his or her hand from the inclination adjustment knobs 13 after the adjustment.

In this case, the position adjustment mechanism 6 of the image display apparatus according to the first embodiment refers to the horizontal adjustment knobs 12 and the inclination adjustment knobs 13.

Therefore, in the image display apparatus according to the first embodiment, when the horizontal adjustment knobs 12 and the inclination adjustment knobs 13 are adjusted, the lenticular lens 5 can be independently adjusted in the horizontal direction and in the inclination direction of FIG. 3 with respect to the frame 9. Since the horizontal adjustment knobs 12 and the inclination adjustment knob 13 are arranged in proximity to each other, the horizontal adjustment knobs 12 and the inclination adjustment knobs 13 can be easily adjusted at a time.

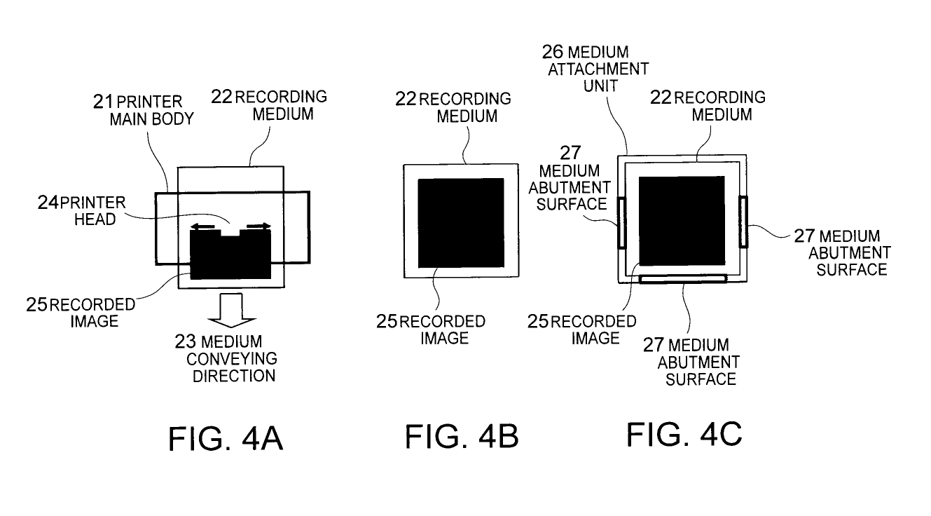

On the other hand, the recorded image 2 is formed by printing of a print apparatus. FIGS. 4(a) to 4(c) are figures illustrating a method for forming a recording medium of the image display apparatus according to the first embodiment.

As shown in FIG. 4(a), for example, while a recording medium 22 which is a recording sheet such as paper is conveyed in a conveying direction 23 in a printer main body 21, and a print apparatus uses a printer head 24 to print the recorded image 25 of a composite image made by composing multiple images parallaxes. As shown in FIG. 4(b), the recorded image 25 is formed on the printed recording medium 22.

Further, as shown in FIG. 4(c), this recording medium 22 is attached to a medium attachment unit 26. In this case, as an indication of the position where the recording medium 22 is attached to the medium attachment unit 26, a medium abutment surfaces 27 are provided on three sides of four external peripheral sides of the medium attachment unit 26, and the external periphery of the recording medium 22 is brought into abutment with the medium abutment surfaces 27, so that the recording medium 22 can be easily positioned with respect to the medium attachment unit 26.

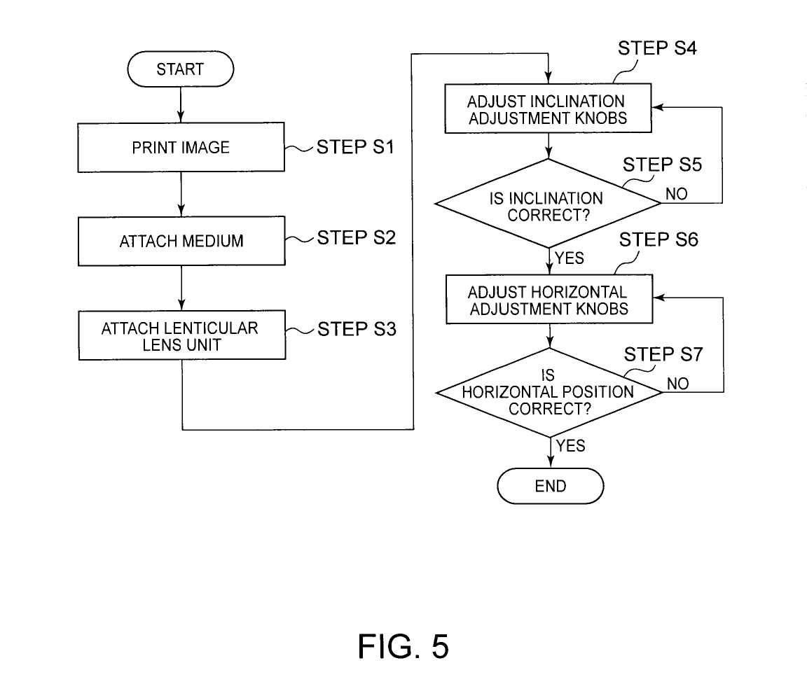

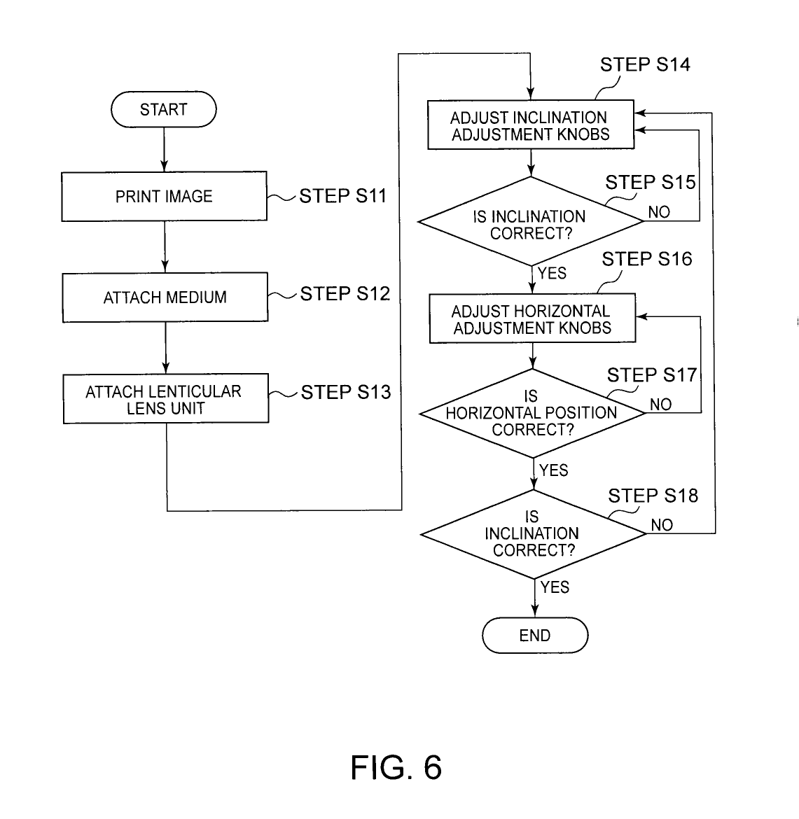

Subsequently, a method for producing the image display apparatus according to the first embodiment will be explained with reference to FIGS. 5, 6. FIG. 5 is a first flowchart illustrating a method for assembling the image display apparatus according to the first embodiment. FIG. 6 is a second flowchart illustrating a method for assembling the image display apparatus according to the first embodiment.

In this case, as shown in FIG. 5, first, the recorded image is printed on the recording medium 22 (step S1). Subsequently, the recording medium 22 having the recorded image 25 printed thereon is attached to the medium attachment unit 26 (step S2). Further, the lenticular lens unit 4 is attached to the medium attachment unit 26 attached to the recording medium 22 (step S3). While a user sees the recorded image 2 through the lenticular lens 5, the user adjusts the inclination adjustment knobs 13 of the position adjustment mechanism 6 of the lenticular lens unit 5 (step S4).

In this case, if the inclination of the recorded image 2 seen through the lenticular lens 5 is correct (YES in step S5), the user adjusts the horizontal adjustment knobs 12 of the position adjustment mechanism 6 of the lenticular lens unit 4 while the user sees the recorded image 2 through the lenticular lens 5 (step S6). If the inclination of the recorded image 2 seen through the lenticular lens 5 is not correct (NO in step S5), step S4 is performed again so that the user adjust the inclination adjustment knobs 13 again.

Further, if the horizontal position of the recorded image 2 seen through the lenticular lens 5 is correct (YES in step S7), the processing is terminated. When the horizontal position of the recorded image 2 seen through the lenticular lens 5 is not correct (NO in step S7), step S6 is performed again, and the user adjusts the horizontal adjustment knobs 12 again.

FIG. 5 shows the procedure for adjusting the inclination adjustment knobs 13 first then adjusting the horizontal adjustment knobs 12, but the embodiment is not limited to this procedure. For example, in the procedure, the horizontal adjustment knobs 12 may be adjusted first, and then the inclination adjustment knob 13 may be adjusted.

As shown in FIG. 6, first, the recorded image 25 is printed on the recording medium 22 (step S11). Subsequently, the recording medium 22 having the recorded image 25 printed thereon is attached to the medium attachment unit 26 (step S21). Further, the lenticular lens unit 4 is attached to the medium attachment unit 26 attached to the recording medium 22 (step S13). While the user sees the recorded image 2 through the lenticular lens 5, the user adjusts the inclination adjustment knobs 13 of the position adjustment mechanism 6 of the lenticular lens unit 5 (step S14).

In this case, if the inclination of the recorded image 2 seen through the lenticular lens 5 is correct (YES in step S15), the user adjusts the horizontal adjustment knobs 12 of the position adjustment mechanism 6 of the lenticular lens unit 4 while the user sees the recorded image 2 through the lenticular lens 5 (step S16).

Further, if the horizontal position of the recorded image 2 seen through the lenticular lens 5 is correct (YES in step S17), the user checks whether the inclination of the recorded image 2 through the lenticular lens 5 is correct or not (step S18).

If the horizontal position of the recorded image 2 seen through the lenticular lens 5 is not correct (NO in step S17), step S16 is performed again, and the user adjusts the horizontal adjustment knobs 12 again.

In this case, if the inclination of the recorded image 2 seen through the lenticular lens 5 is correct (YES in step S18), the processing is terminated.

If the inclination of the recorded image 2 seen through the lenticular lens 5 is not correct (NO in step S18), this means that the inclination in the recorded image 2 is deviated, which was once correctly adjusted while the horizontal adjustment knobs 12 were adjusted, and therefore, step S14 is performed again, and the inclination adjustment knobs 13 are adjusted again and the horizontal adjustment knobs 12 are adjusted again (step S14 to step S18).

Therefore, according to the flowchart of FIG. 6, whether the inclination adjustment knobs 13 are correct or not is checked again, and therefore, more accurately positioned adjustment state can be attained as compared with the flowchart of FIG. 5.

Like FIG. 5, FIG. 6 shows the procedure for adjusting the inclination adjustment knobs 13 first and the adjusting the horizontal adjustment knobs 12, but the procedure is not limited thereto. For example, in the procedure, the horizontal adjustment knobs 12 may be adjusted first, and then the inclination adjustment knob 13 may be adjusted.

As described above, according to the image display apparatus of the first embodiment, the user can easily adjust the position of the lenticular lens 5 while the user sees the displayed recorded image 2 with the recorded image of the recording medium 1.

### Second Embodiment

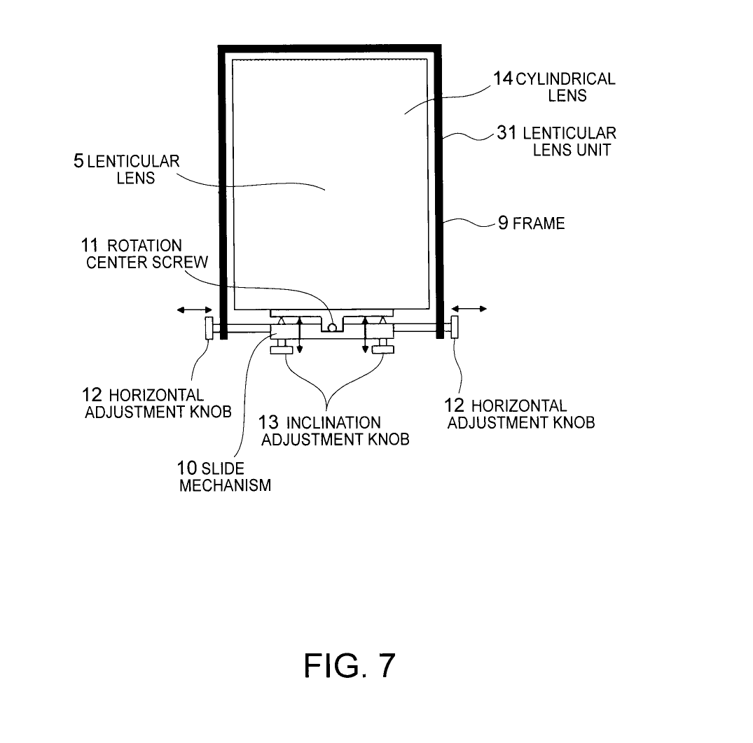

An image display apparatus according to a second embodiment will be hereinafter explained with reference to FIG. 7. The second embodiment is different from the first embodiment only in a lenticular lens unit 31, and the second embodiment is the same as the first embodiment except the description of the lenticular lens unit 31, and therefore, the same portions are denoted with the same reference numerals, and detailed explanation thereabout is omitted. FIG. 7 is a longitudinal sectional view illustrating a lenticular lens unit of the image display apparatus according to the second embodiment.

As shown in FIG. 7, a lenticular lens 5 is connected via a rotation center screw 11 with a slide mechanism 10 provided at a lower portion of FIG. 7 with respect to a frame 9. The lenticular lens 5 is configured in such a manner that many inverted U-shaped cylindrical lenses 14 are arranged side by side. Further, horizontal adjustment knobs 12 are provided to connect with the slide mechanism 10, and for example, in a case where the slide mechanism 10 is of a direct-acting method, a user grabs one of or both of the horizontal adjustment knobs 12 and moves the knobs in a horizontal direction, so that the slide mechanism 10 connected with the lenticular lens 5 can be adjusted in the horizontal direction of FIG. 7. In a case where the slide mechanism 10 is of a feed screw method, a user rotates one of or both of the horizontal adjustment knobs 12, so that the slide mechanism 10 connected with the lenticular lens 5 can be adjusted in the horizontal direction of FIG. 7. In a case where the horizontal adjustment knobs 12 are of a screw method, the position in the horizontal direction is less likely to deviate from the adjusted state because of the friction of the screw even if the user releases his or her hand from the horizontal adjustment knobs 12 after the adjustment of the horizontal adjustment knobs 12.

Further, inclination adjustment knobs 13 are provided to be in contact with a component connected with the rotation center screw 11 of the slide mechanism 10, for example, in a case where the inclination adjustment knobs 13 are a direct-acting method, a user grabs one of or both of the knobs of the inclination adjustment knobs 13 at the right and the left and moves the knobs in the vertical direction, and pushes or pulls the contact portions at the right and the left of the inclination adjustment knobs 13, so that the user can adjust the inclination of the component connected with the rotation center screw 11 of the slide mechanism 10 connected with the lenticular lens 5 with respect to the rotation center screw 11 serving as the center of rotation. In a case where the inclination adjustment knobs 13 are of a feed screw method, a user rotates one of or both of the knobs of the inclination adjustment knobs 13, and pushes or pulls the contact portions at the right and the left of the inclination adjustment knobs 13, so that the user can adjust the inclination of the component connected with the rotation center screw 11 of the slide mechanism 10 connected with the lenticular lens 5 with respect to the rotation center screw 11 serving as the center of rotation. When the inclination adjustment knobs 13 are of a screw method, the inclination is less likely to deviate from the adjusted state because of the friction of the screw even if the user releases his or her hand from the inclination adjustment knobs 13 after the adjustment of the inclination adjustment knobs 13.

In this case, the position adjustment mechanism of the image display apparatus according to the second embodiment refers to the horizontal adjustment knobs 12 and the inclination adjustment knobs 13.

Therefore, in the image display apparatus according to the second embodiment, like the first embodiment, when the horizontal adjustment knobs 12 and the inclination adjustment knobs 13 are adjusted, the lenticular lens 5 can be independently adjusted in the horizontal direction and in the inclination direction of FIG. 7 with respect to the frame 9. Since the horizontal adjustment knobs 12 and the inclination adjustment knob 13 are arranged in proximity to each other, the horizontal adjustment knobs 12 and the inclination adjustment knobs 13 can be easily adjusted at a time.

### Third Embodiment

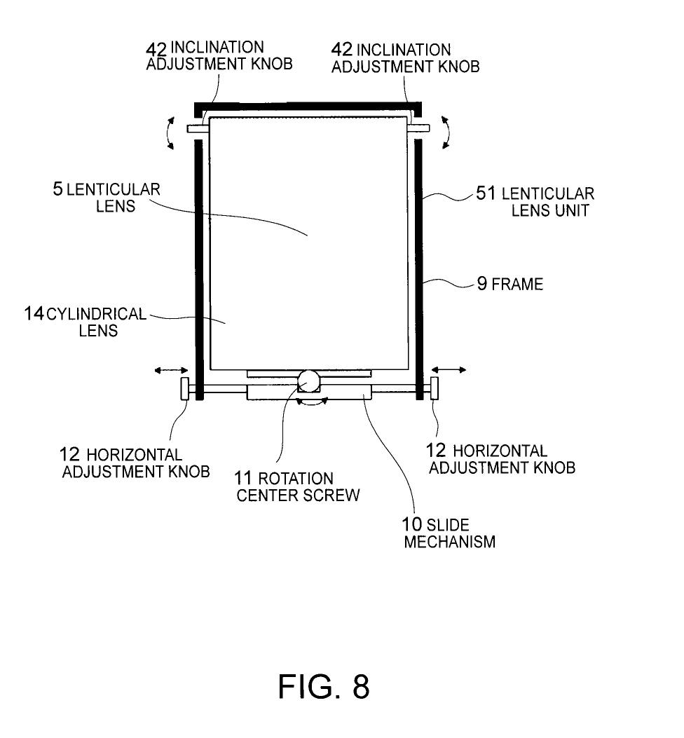

An image display apparatus according to a third embodiment will be hereinafter explained with reference to FIG. 8. The third embodiment is different from the first embodiment only in a lenticular lens unit 41 and inclination adjustment knobs 42, and the third embodiment is the same as the first embodiment except the description of the lenticular lens unit 41 and the inclination adjustment knobs 42, and therefore, the same portions are denoted with the same reference numerals, and detailed explanation thereabout is omitted. FIG. 8 is a longitudinal sectional view illustrating a lenticular lens unit of the image display apparatus according to the third embodiment.

As shown in FIG. 8, a lenticular lens 5 is connected via a rotation center screw 11 with a slide mechanism 10 provided at a lower portion of FIG. 8 with respect to a frame 9. The lenticular lens 5 is configured in such a manner that many inverted U-shaped cylindrical lenses 14 are arranged side by side. Further, horizontal adjustment knobs 12 are provided to connect with the slide mechanism 10 at the lower portion of FIG. 8, and for example, in a case where the slide mechanism 10 is of a direct-acting method, a user grabs one of or both of the horizontal adjustment knobs 12 and moves the horizontal adjustment knobs 12 in a horizontal direction, so that the slide mechanism 10 connected with the lenticular lens 5 can be adjusted in the horizontal direction of FIG. 8. In a case where the slide mechanism 10 is of a feed screw method, a user rotates one of or both of the horizontal adjustment knobs 12, so that the slide mechanism 10 connected with the lenticular lens 5 can be adjusted in the horizontal direction of FIG. 8. In a case where the horizontal adjustment knobs 12 are of a screw method, the position in the horizontal direction is less likely to deviate from the adjusted state because of the friction of the screw even if the user releases his or her hand from the inclination adjustment knob 13 after the adjustment of the inclination adjustment knob 13.

However, inclination adjustment knobs 42 are provided to be in contact with the lenticular lens 5 at the upper portion of FIG. 8, and where the user grabs one of or both of the knobs of the inclination adjustment knobs 42 at the upper and lower sides and moves the knobs in the vertical direction, so that the user can adjust the inclination of the component connected with the rotation center screw 11 of the slide mechanism 10 connected with the lenticular lens 5 with respect to the rotation center screw 11 serving as the center of rotation, and can adjust the lenticular lens 5 in the inclination direction of FIG. 8. In order to prevent deviation from the adjusted state after the inclination has been adjusted with the inclination adjustment knobs 42 in the image display apparatus according to the third embodiment, the rotation center screw 11 may be loosened while the inclination is adjusted with the inclination adjustment knobs 42, and the rotation center screw 11 may be tightened after the inclination has been adjusted. In this case, the position adjustment mechanism of the image display apparatus according to the third embodiment refers to the horizontal adjustment knobs 12 and the inclination adjustment knobs 42.

Therefore, in the image display apparatus according to the third embodiment, when the horizontal adjustment knobs 12 and the inclination adjustment knobs 42 are adjusted, the lenticular lens 5 can be independently adjusted in the horizontal direction and in the inclination direction of FIG. 8 with respect to the frame 9.

Further, in the image display apparatus according to the third embodiment, the lenticular lens 5 including the inclination adjustment knobs 42 can be inclined, and therefore, this allows the user to make adjustment in a more intuitive manner.

### Fourth Embodiment

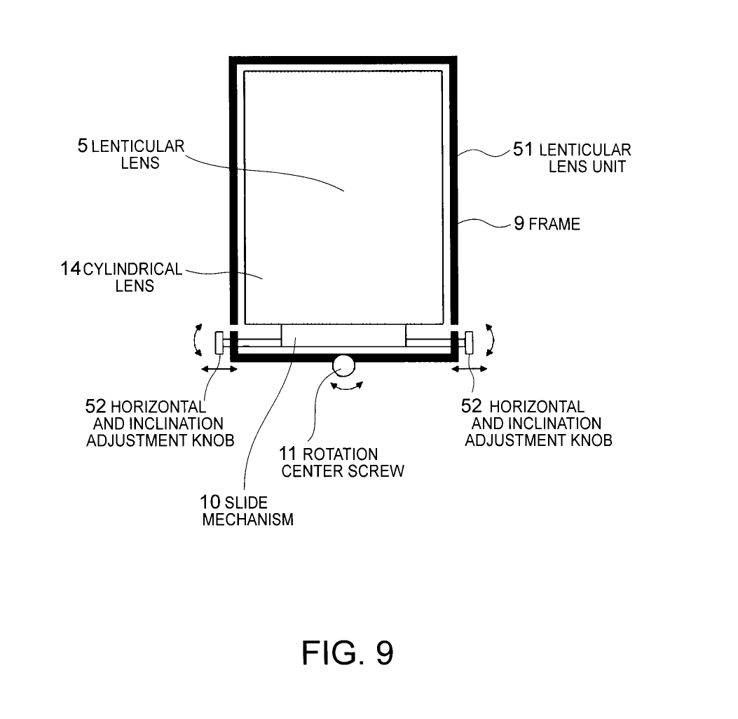

An image display apparatus according to the fourth embodiment will be hereinafter explained with reference to FIG. 9. The fourth embodiment is different from the first embodiment only in a lenticular lens unit 51 and horizontal and inclination adjustment knobs 52, and the fourth embodiment is the same as the first embodiment except the description of the lenticular lens unit 51 and the horizontal and inclination adjustment knobs 52, and therefore, the same portions are denoted with the same reference numerals, and detailed explanation thereabout is omitted. FIG. 9 is a longitudinal sectional view illustrating a lenticular lens unit of the image display apparatus according to the fourth embodiment.

As shown in FIG. 9, a lenticular lens 5 is connected via a rotation center screw 11 with a slide mechanism 10 provided at a lower portion of FIG. 9 with respect to a frame 9. The lenticular lens 5 is configured in such a manner that many inverted U-shaped cylindrical lenses 14 are arranged side by side.

However, the horizontal adjustment knobs 12 and the inclination adjustment knobs 13, 42 are not separately provided, and instead, the horizontal and inclination adjustment knob 52 is provided. The horizontal and inclination adjustment knob 52 has such structure that the horizontal adjustment knob 12 and the inclination adjustment knobs 13, 42 are integrated.

In this case, the horizontal and inclination adjustment knobs 52 are provided to connect with a component connected with the rotation center screw 11 and the slide mechanism 10, and, for example, in a case where the slide mechanism 10 is of a direct-acting method, a user grabs one of or both of the knobs of the horizontal and inclination adjustment knobs 52 and moves the knobs in the horizontal direction, so that the user can adjust the slide mechanism 10 connected with the lenticular lens 5 in the horizontal direction of FIG. 9. In a case where the slide mechanism 10 is of a feed screw method, a user rotates one of or both of the knobs of the horizontal and inclination adjustment knobs 52, so that the user can adjust the slide mechanism 10 connected with the lenticular lens 5 in the horizontal direction of FIG. 8. When the horizontal and inclination adjustment knobs 52 are of a screw method, the position in the horizontal direction is less likely to deviate from the adjusted state because of the friction of the screw even if the user releases his or her hand from the horizontal and inclination adjustment knobs 52 after the user adjusts the horizontal and inclination adjustment knob 52.

Not only the position in the horizontal direction is adjusted but also the user grabs one of or both of the knobs of the horizontal and inclination adjustment knobs 52 at the right and the left and moves the knobs in the vertical direction and inclines the component connected with the rotation center screw 11 of the slide mechanism 10, so that the user can also adjust the lenticular lens 5 in the inclination direction of FIG. 9 with respect to the rotation center screw 11 serving as the center of rotation. In order to prevent deviation from the adjusted state after the inclination has been adjusted with the horizontal and inclination adjustment knobs 52 in the image display apparatus according to the fourth embodiment, the rotation center screw 11 maybe loosened while the inclination is adjusted with the horizontal and inclination adjustment knobs 52, and the rotation center screw 11 maybe tightened after the inclination has been adjusted with the horizontal and inclination adjustment knobs 52.

In this case, the position adjustment mechanism of the image display apparatus according to the fourth embodiment refers to the horizontal and inclination adjustment knobs 52.

Therefore, in the image display apparatus according to the fourth embodiment, when the horizontal and inclination adjustment knobs 52 are adjusted, the lenticular lens 5 can be independently adjusted in the horizontal direction and in the inclination direction of FIG. 9 with respect to the frame 9.

Further, in the image display apparatus according to the fourth embodiment, the lenticular lens 5 including the horizontal and inclination adjustment knobs 52 can be inclined, and therefore, this allows the user to make adjustment in a more intuitive manner. In addition, in the image display apparatus according to the fourth embodiment, the lenticular lens 5 can be easily adjusted at a time in the horizontal direction and the inclination direction of FIG. 9 with respect to the frame 9 using the horizontal and inclination adjustment knobs 52.

### Fifth Embodiment

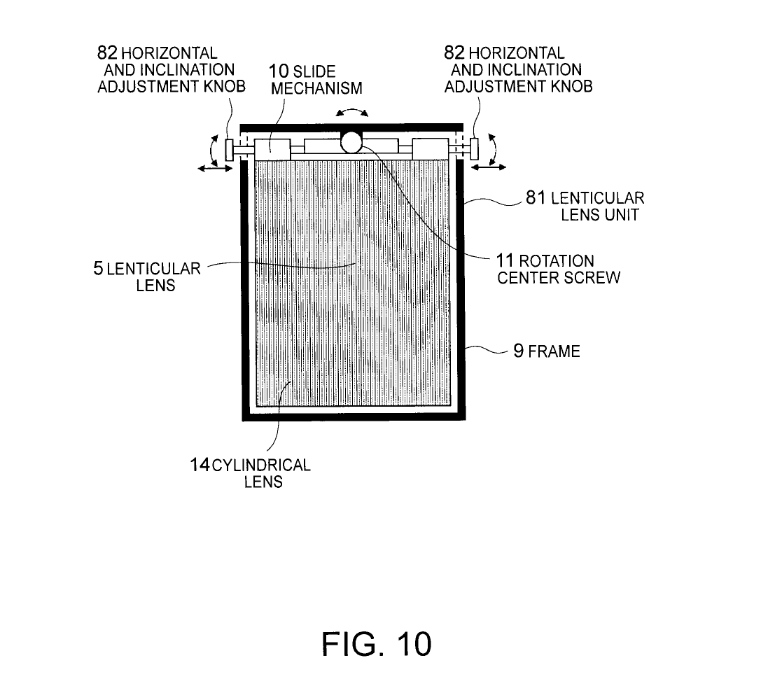

An image display apparatus according to a fifth embodiment will be hereinafter explained with reference to FIG. 10. The fifth embodiment is different from the first embodiment only in a lenticular lens unit 81 and a horizontal and inclination adjustment knobs 82, and the fifth embodiment is the same as the first embodiment except the description of the lenticular lens unit 81 and a horizontal and inclination adjustment knobs 82, and therefore, the same portions are denoted with the same reference numerals, and detailed explanation thereabout is omitted. FIG. 10 is a longitudinal sectional view illustrating a lenticular lens unit of the image display apparatus according to the fifth embodiment.

As shown in FIG. 10, a lenticular lens 5 is connected via a rotation center screw 11 with a slide mechanism 10 provided at an upper portion of FIG. 10 with respect to a frame 9. The lenticular lens 5 is configured in such a manner that many inverted U-shaped cylindrical lenses 14 are arranged side by side.

However, the horizontal adjustment knobs 12 and the inclination adjustment knobs 13, 42 are not separately provided, and instead, the horizontal and inclination adjustment knob 82 is provided. The horizontal and inclination adjustment knob 82 has such structure that the horizontal adjustment knob 12 and the inclination adjustment knobs 13, 42 are integrated.

In this case, the horizontal and inclination adjustment knobs 82 are provided to connect with a component connected with the rotation center screw 11 and the slide mechanism 10, and, for example, in a case where the slide mechanism 10 is of a direct-acting method, a user grabs one of or both of the knobs of the horizontal and inclination adjustment knobs 82 and moves the knobs in the horizontal direction, so that the user can adjust the slide mechanism 10 connected with the lenticular lens 5 in the horizontal direction of FIG. 10. In a case where the slide mechanism 10 is of a feed screw method, a user rotates one of or both of the knobs of the horizontal and inclination adjustment knobs 82, so that the user can adjust the slide mechanism 10 connected with the lenticular lens 5 in the horizontal direction of FIG. 10. When the horizontal and inclination adjustment knobs 82 are of a screw method, the position in the horizontal direction is less likely to deviate from the adjusted state because of the friction of the screw even if the user releases his or her hand from the horizontal and inclination adjustment knobs 82 after the user adjusts the horizontal and inclination adjustment knob 82.

Not only the position in the horizontal direction is adjusted but also the user grabs one of or both of the knobs of the horizontal and inclination adjustment knobs 82 at the right and the left and moves the knobs in the vertical direction and inclines the component connected with the rotation center screw 11 of the slide mechanism 10, so that the user can also adjust the lenticular lens 5 in the inclination direction of FIG. 10 with respect to the rotation center screw 11 serving as the center of rotation.

In order to prevent deviation from the adjusted state after the inclination has been adjusted with the horizontal and inclination adjustment knobs 82 in the image display apparatus according to the fifth embodiment, the rotation center screw 11 may be loosened while the inclination is adjusted with the horizontal and inclination adjustment knobs 82, and the rotation center screw 11 maybe tightened after the inclination has been adjusted with the horizontal and inclination adjustment knobs 82.

In this case, the position adjustment mechanism of the image display apparatus according to the fifth embodiment refers to the horizontal and inclination adjustment knobs 82.

Therefore, in the image display apparatus according to the fifth embodiment, when the horizontal and inclination adjustment knobs 82 are adjusted, the lenticular lens 5 can be independently adjusted in the horizontal direction and in the inclination direction of FIG. 10 with respect to the frame 9.

In addition, in the image display apparatus according to the fifth embodiment, the lenticular lens 5 including the horizontal and inclination adjustment knobs 82 can be inclined, and therefore, this allows the user to make adjustment in a more intuitive manner. Further, in the image display apparatus according to the fifth embodiment, the lenticular lens 5 can be easily adjusted at a time in the horizontal direction and the inclination direction of FIG. 10 with respect to the frame 9 using the horizontal and inclination adjustment knobs 82.

### Sixth Embodiment

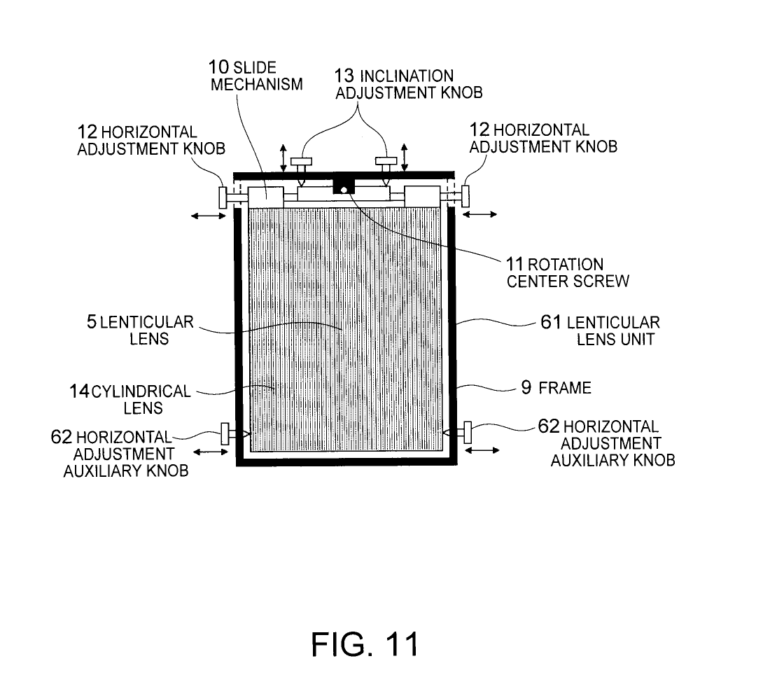

An image display apparatus according to a sixth embodiment will be hereinafter explained with reference to FIG. 11. The sixth embodiment is different from the first embodiment only in a lenticular lens unit 61 and horizontal adjustment auxiliary knobs 62, and the sixth embodiment is the same as the first embodiment except the description of the lenticular lens unit 61 and the horizontal adjustment auxiliary knobs 62, and therefore, the same portions are denoted with the same reference numerals, and detailed explanation thereabout is omitted. FIG. 11 is a longitudinal sectional view illustrating a lenticular lens unit of the image display apparatus according to the sixth embodiment.

As shown in FIG. 11, a lenticular lens 5 is connected via a rotation center screw 11 with a slide mechanism 10 provided at an upper portion of FIG. 11 with respect to a frame 9. The lenticular lens 5 is configured in such a manner that many inverted U-shaped cylindrical lenses 14 are arranged side by side.

In this case, the horizontal adjustment auxiliary knobs 62 (which may be hereinafter also referred to as horizontal adjustment auxiliary units) are provided at a lower portion of FIG. 11 in the image display apparatus according to the fifth embodiment. For example, when there is a high level of friction between the print surface of the recording medium 1 and the surface of the lenticular lens 5, it is difficult to slightly move the lenticular lens 5 with only the inclination adjustment knob 13 and the horizontal adjustment knob 12 provided at an upper portion of FIG. 11.

In this case, in the image display apparatus according to the sixth embodiment, the horizontal adjustment auxiliary knobs 62 are adjusted at the same time, so that the adjusting force is applied to the lower portion of the lenticular lens 5, and this allows the lenticular lens 5 to be slightly moved.

It should be noted that the horizontal adjustment auxiliary knobs 62 are arranged to be in contact with the lenticular lens 5, and, for example, when the horizontal adjustment auxiliary knobs 62 are of the direct-acting method, a user grabs one of or both of the knobs of the horizontal adjustment auxiliary knobs 62 at the right and the left and moves the horizontal adjustment auxiliary knobs 62 in a horizontal direction, and pushes or pulls the contact portions at the right and the left of the horizontal adjustment auxiliary knobs 62, so that the adjusting force can also be applied to the lower portion of the lenticular lens 5. Ina case where the horizontal adjustment auxiliary knobs 62 are of a feed screw method, a user rotates one of or both of the knobs of the horizontal adjustment auxiliary knobs 62, and pushes or pulls the contact portions at the right and the left of the horizontal adjustment auxiliary knobs 62, so that the adjusting force can also be applied to the lower portion of the lenticular lens 5. When the horizontal adjustment auxiliary knobs 62 are of a screw method, the inclination is less likely to deviate from the adjusted state because of the friction of the screw even if the user releases his or her hand from the knobs of the horizontal adjustment auxiliary knobs 62 after the horizontal adjustment auxiliary knobs 62 have been adjusted.

As described above, even when there is a high level of friction between the print surface of the recording medium 1 and the surface of the lenticular lens 5 in the image display apparatus according to the sixth embodiment, the horizontal adjustment auxiliary knobs 62 are adjusted at the same time, the adjusting force is also applied to the lower portion of the lenticular lens 5, so that the user can slightly move the lenticular lens 5.

In this case, a single set of horizontal adjustment auxiliary knobs 62 are provided, but two or more sets of horizontal adjustment auxiliary knobs 62 may be provided. The horizontal adjustment auxiliary knobs 62 are combined with the slide mechanism 10, the rotation center screw 11, the horizontal adjustment knobs 12, and the inclination adjustment knobs 13, like the first embodiment. Alternatively, the horizontal adjustment auxiliary knobs 62 may be combined with the image display apparatuses according to the second embodiment to the fifth embodiment, and a position adjustment mechanism 6 according to another embodiment.

### Seventh Embodiment

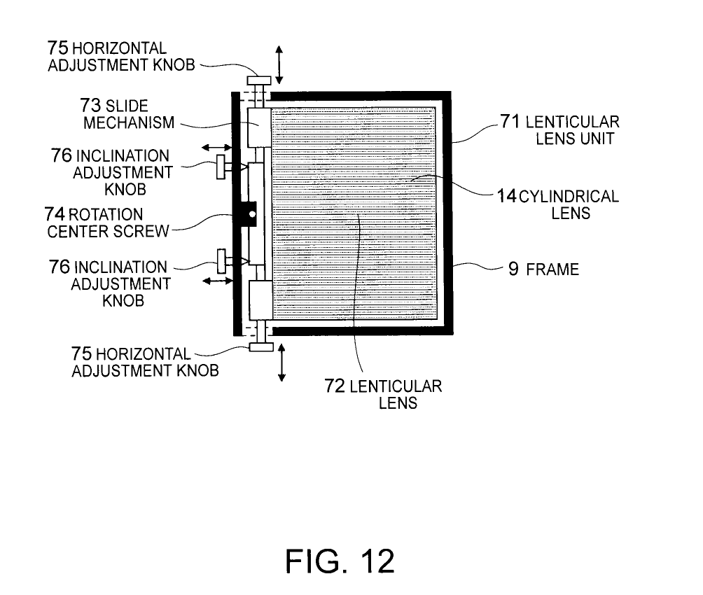

An image display apparatus according to a seventh embodiment will be hereinafter explained with reference to FIG. 12. The seventh embodiment is different from the first embodiment only in a lenticular lens unit 71, a lenticular lens 72, a slide mechanism 73, a rotation center screw 74, horizontal adjustment knobs 75, inclination adjustment knobs 76, and the seventh embodiment is the same as the first embodiment except the description of the lenticular lens unit 71, the lenticular lens 72, the slide mechanism 73, the rotation center screw 74, the horizontal adjustment knobs 75, and the inclination adjustment knobs 76, and therefore, the same portions are denoted with the same reference numerals, and detailed explanation thereabout is omitted. FIG. 12 is a longitudinal sectional view illustrating a lenticular lens unit of the image display apparatus according to the seventh embodiment.

As shown in FIG. 12, the image display apparatus according to the seventh embodiment is an image display apparatus in which many inverted U-shaped cylindrical lenses 14 constituting the lenticular lens 72 are arranged side by side in the horizontal direction of FIG. 12. Therefore, the slide mechanism 73, the rotation center screw 74, the horizontal adjustment knobs 75, and the inclination adjustment knobs 76 of the lenticular lens 72 are arranged at the left side of the lenticular lens 72.

Therefore, the horizontal adjustment knobs 75 do not adjust the position, in the horizontal direction of FIG. 12, of the lenticular lens 72 connected via the rotation center screw 74 with the slide mechanism 73, but adjust the positions of the lenticular lens 72 in the vertical direction of FIG. 10. Likewise, the inclination adjustment knobs 76 make adjustment in the inclination direction of FIG. 12 with respect to the rotation center screw 74 of the slide mechanism 73 serving as the center of rotation.

As described above, the image display apparatus according to the seventh embodiment is an image display apparatus in which many inverted U-shaped cylindrical lenses 14 constituting the lenticular lens 72 are arranged side by side in the horizontal direction of FIG. 12. A user can adjust the position of the lenticular lens 72 in the vertical direction of FIG. 12 by using the horizontal adjustment knobs 75. In addition, the user can make adjustment in the inclination direction of FIG. 12 by using the inclination adjustment knobs 76.

In the image display apparatus according to the seventh embodiment, the slide mechanism 73, the rotation center screw 74, the horizontal adjustment knobs 75, and the inclination adjustment knobs 76 may not be arranged at the left side of the lenticular lens 72 but may be arranged at the right side thereof. In the image display apparatus according to the seventh embodiment, the slide mechanism 73, the rotation center screw 74, the horizontal adjustment knobs 75, and the inclination adjustment knobs 76 are arranged at the left side or the right side of the lenticular lens 72 like the first embodiment. Alternatively, the position adjustment mechanism 6 of the image display apparatuses according to the second to sixth embodiments and other embodiments may be arranged at the left side or the right side of the lenticular lens 72.

According to the image display apparatus of at least one of the embodiments explained above, the recorded image 25 and the lenticular lens 5 can be positioned with a simple structure.

It should be noted that the present invention is not limited to the embodiments explained above, and it is to be understood that the present invention may be modified in various manners.

For example, the number of lenticular lenses 5 in the lenticular lens unit 4, 31, 41, 51, 61, 71, 81 has not been particularly mentioned, but the present invention is not limited to a single lenticular lens 5. It should be understood that two or more lenticular lenses 5 may be provided.

In short, the present invention is not limited to the embodiments as they are. When the present invention is carried out, it can be embodied upon modifying constituent elements without deviating from the gist thereof. Multiple constituent elements disclosed in the embodiments can be combined appropriately, and various modes may be formed. For example, some of constituent elements may be omitted from all the constituent elements disclosed in the embodiments. Further, constituent elements in different embodiments may be appropriately combined.

What is claimed is:

1. An image display apparatus comprising:
a recording medium on which a composite image obtained by composing a plurality of images corresponding to respective parallaxes is printed by a print apparatus;
a lenticular lens having a plurality of cylindrical lenses arranged side by side, and configured to display the composed image separately for each direction of parallax; and
a position adjustment mechanism configured to adjust relative position of the recording medium and the lenticular lens, and
wherein the position adjustment mechanism includes:
an inclination adjustment unit capable of changing an inclination angle of at least one of the recording medium and the lenticular lens; and
a horizontal adjustment unit capable of moving at least one of the recording medium and the lenticular lens in a substantially perpendicular direction to a border line of the cylindrical lens,
wherein the inclination adjustment unit and the horizontal adjustment unit can make adjustment independently,
a rotation center of the inclination adjustment unit is provided at a portion of the horizontal adjustment unit, and the inclination angle can be changed on the basis of the rotation center which is a reference.

2. The image display apparatus according to claim 1, wherein the inclination adjustment unit and the horizontal adjustment unit are provided at an upper portion of the lenticular lens.

3. The image display apparatus according to claim 2 further comprising a horizontal adjustment auxiliary unit provided at a lower portion of the lenticular lens.

4. The image display apparatus according to claim 1, wherein the inclination adjustment unit and the horizontal adjustment unit are provided at a lower portion of the lenticular lens.

5. The image display apparatus according to claim 1, wherein the inclination adjustment unit is provided at an upper portion of the lenticular lens, and the horizontal adjustment unit is provided at a lower portion of the lenticular lens.

6. The image display apparatus according to claim 1, wherein the inclination adjustment unit and the horizontal adjustment unit are arranged as an integrated structure at a lower portion of the lenticular lens.

7. The image display apparatus according to claim 1, wherein two or more lenticular lenses constitute the image display apparatus.
